(19) United States
(12) Patent Application Publication
(10) Pub. No.: US 2008/0031226 A1
(43) Pub. Date: Feb. 7, 2008

(54) Scalable, high-availability network

(75) Inventors: Kai Y. Eng, Atlantic Highlands, NJ (US); Pramod Pancha, Somerset, NJ (US); Siu Yu Yuen, Kowloon (HK)

Correspondence Address: KAPLAN GILMAN GIBSON & DERNIER L.L.P., 900 ROUTE 9 NORTH, WOODBRIDGE, NJ, 07095, US

(73) Assignee: Boro Networks Inc., Atlantic Highlands, NJ (US)

(21) Appl. No.: 11/497,146

(22) Filed: Aug. 1, 2006

(51) Int. Cl. H04L 12/66

(52) U.S. Cl. 370/352; 370/218

(57) ABSTRACT

A multiplicity of users is connected to a network, as are m servers. The users are organized into n user groups, each including a plurality of users, such that all the users in a group are part of a common database which permits intercommunication between them. That database is duplicated in a subset of p of the servers, and the subset shares the processing load of the corresponding user group. When a user in the respective user group attempts to communicate with another user, one of the servers in the subset p will accommodate the necessary processing initiate set up of the connection. At the same time, each server accommodates users in q different groups. Should one of the servers fail, each of the other servers in each subset p accommodating the failing server's users will accommodate the failed server's share of those users. Thus, the processing load of each user group is handled with a redundancy of p (the number of servers in a subset), ensuring a high level of availability.

### BACKGROUND OF THE INVENTION

The present invention relates generally to computerized networks and, more particularly, concerns a method and in network architecture which provide a scalable, high-availability network.

The present invention will be described in terms of its application to voice over Internet protocol (VoIP) networks, but those skilled in the art will appreciate that it is applicable to any type of network.

VoIP is enjoying wide use in public telephone services, such as Vonage, Comcast, and Verizon, as well as in enterprise telephony systems, such as PBX (Private Branch Exchange). In VoIP technology, the latest standard is called Session Initiation Protocol (SIP), which was formally adopted by the Internet standards organization, IETF, in 2002 and is currently implemented in many VoIP networks and systems.

A SIP-based VoIP system or network operates in a very different manner than traditional digital telephony systems. For example, in traditional digital telephony systems, telephone terminals are connected to a telephone switch through dedicated wiring, and calls between telephones are made entirely through the telephone switch. That is, both control information (signaling) and media information (voice signals) flow from an originating telephone to the telephone switch and then from the telephone switch to a destination telephone. Thus, all information is passed through the Telephone Switch, or equivalently the Telephone Network.

A SIP-based VoIP system, on the other hand, is designed using the Internet model, according to which telephone terminals (or IP phones) are connected to an IP network as intelligent clients, similar to a computer or PC. These IP phones can communicate directly over the IP network, with voice as an application and SIP as the signaling protocol. Consequently, an IP phone can call another IP phone directly, with SIP as the common protocol, in the same manner that two computers communicate with each other over the Internet. To achieve this with IP networking, the two terminals (or computers) must know one another's IP addresses, so that their packets can be routed to the intended destinations. Therefore, for a large collection of IP phones to function together as a meaningful telephony system, there must be a mechanism through which they can make their IP address information available to one another. In the SIP environment, this role is fulfilled by an SIP server (or the SIP Proxy and Registrar).

A SIP server behaves like a computer server in a computer network, in that its presence tends to be permanent and its IP address is well known to all the clients (phones or terminals). The clients, on the other hand, may be subject to frequent changes, moves, additions and deletions. In a SIP system, each phone is required to register with the SIP server periodically in order to update its presence information, and the SIP server maintains a database of every phone's designations (name, ID or “phone number”) and associated IP addresses. The registration process consumes both processing power and memory space in each SIP server. Thus, a SIP server can only support only the number of users that its own resources permit.

For a phone to make a call to another phone, it has to go through a two-step process in SIP. First, the originating phone has to send a message (called an INVITE message) to the SIP server indicating that it wishes to talk to a particular receiving phone. Since the SIP server maintains a database of every phone's IP address, it can forward the INVITE message from originating phone, together with its IP address and associated control information. Upon receipt of the INVITE message, the receiving phone can send an acknowledgement or acceptance message back to originating phone via the SIP server. In this exchange, SIP also allows the two end points to negotiate and agree on a common set of parameters for communication such as codec type, bit rate and so on, whereby the protocol provides a session setup mechanism between the two phones.

When the voice session finally begins, packets are sent directly between the two phones without traversing through the SIP server. In this way, the SIP server acts as a relay for the signaling packets but not the media (voice) packets between the two phones. The SIP server has an essential role in the session initiation and control functions but not the media transmission. In commercial products, a SIP-based IP-PBX is essentially a SIP server supporting SIP phones attached to an enterprise IP network so that the phones can work together with the same features as a traditional digital PBX. Also, for a large enterprise with many offices, it is often necessary to network the IP-PBX systems in different offices together so that the entire enterprise VoIP network can work as an integrated telephone system.

It should be appreciated that the SIP Server is an essential component in the SIP network infrastructure. If a SIP Server fails, it would be difficult for the phones associated with that server to have effective telephone service. In this sense, a SIP Server is analogous to a legacy Telephone Switch, and its reliability is of great concern to the users for whom phone service is a critical mission. “High Availability” (HA) has come to be used in this context as having a very high reliability or very low downtime.

A known technique for providing HA is to use redundancy. For example, in addition to having a SIP Server serving a certain group of phones, a spare unit is used in a standby mode. For the redundancy arrangement to have a fast failure recovery time, the registration or user database of the active SIP Server must somehow be duplicated in the standby SIP Server. This can be done by actual copying of the database from the active server to the standby server on an ongoing basis or, alternatively, each phone can be required to register with both servers in its routine registration procedure. In either case, the principle remains that there is a redundant server in the network, and the main drawback is its substantial cost increase, essentially doubling the server cost.

It is also well known in the art that, instead of having a redundant unit protecting an active unit (one-for-one protection), one spare unit may protect N active units (one-for-N protection), thereby reducing the cost impact considerably. It is also appreciated that the reliability of this scheme is compromised compared to the one-for-one scheme, because there is only one spare unit, allowing for only one failure before the system fails. The main shortcoming of this approach, however, is that it does not adapt well to the SIP environment. The reason is that the standby server needs to maintain all the phone databases of the N active servers, either by direct copying or by having each phone registering its own server plus the standby server. As N, the number of active SIP Servers, increases, so does the memory requirement of the standby unit. Therefore, this protection arrangement is not scalable and is not suitable for use in large networks. The main challenge for practical commercial applications is then how to design a protection scheme for HA such that:
the cost is minimized (or as attractive as the one-for-N arrangement),
the database maintenance requirement is minimized as in the one-for-one scheme, and
the performance is close to the one-for-one method.

### SUMMARY OF THE INVENTION

In accordance with one aspect of the invention, a multiplicity of users is connected to a network, as are m servers. The users are organized into n user groups, each including a plurality of users, such that all the users in a group are part of a common database which permits intercommunication between them. That database is duplicated in a subset of p of the servers, which shares the processing load of the corresponding user group. When a user in the corresponding user group attempts to communicate with another user, one of the servers in the subset p will accommodate the necessary processing to initiate set up of the connection. At the same time, each server accommodates users in q different groups. Should one of the servers fail, each of the other servers accommodating the failing server's users will accommodate the failed server's share of those users. Thus, the processing load of each user group is handled with a redundancy of p (the number of servers in a subset), assuring a high level of availability.

### BRIEF DESCRIPTION OF THE DRAWINGS

The foregoing brief description, as well as further objects, features, and advantages of the present invention will be understood more completely from the following detailed description of a presently preferred, but nonetheless illustrative embodiment, with reference being had to the accompanying drawings, in which:

FIG. 1 is a schematic block diagram illustrating a fundamental aspect of the present invention;

FIG. 2 is a schematic block diagram illustrating a network configuration in accordance with a preferred embodiment of the invention; and

FIG. 3 is a schematic block diagram illustrating a network configuration in which 1-for-1 redundancy is provided for each server, as is well-known.

### DETAILED DESCRIPTION OF THE PREFERRED EMBODIMENTS

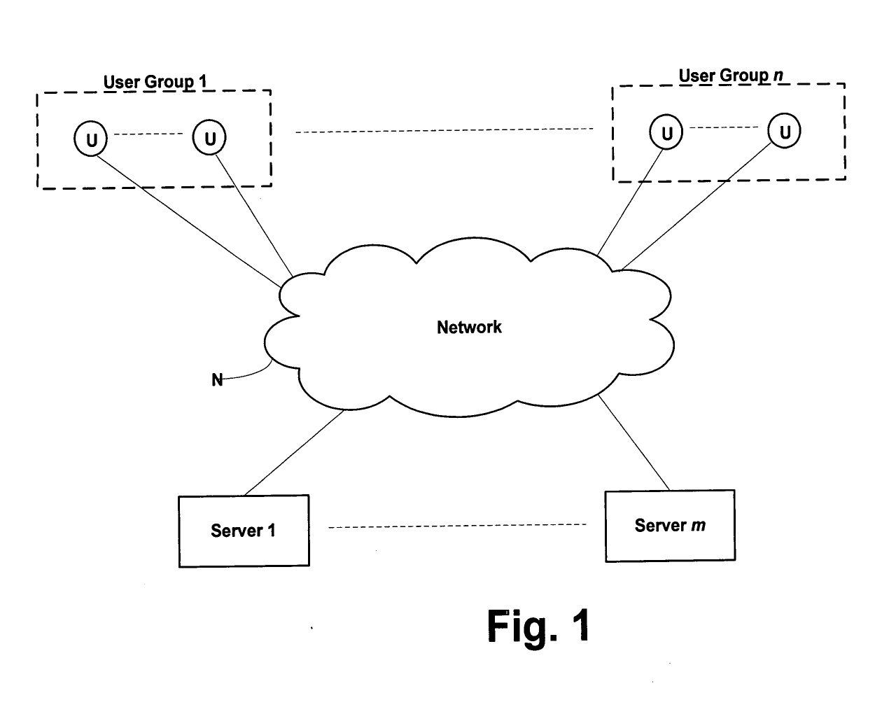

Turning now to the drawings, FIG. 1 is a schematic block diagram illustrating a fundamental aspect of the present invention. A multiplicity of users, U, are connected to a network N or a network conglomeration, such as the Internet, as are m servers. The users U are organized into n user groups, each including a plurality of users, such that all the users in a group are part of a common database which permits intercommunication between them. That database is duplicated in a subset p of the servers, which share the processing load of the corresponding user group. That is, when a user in the respective user group attempts to communicate with another user, one of the servers in the subset p will accommodate the necessary processing. At the same time, each server accommodates users from q different groups. Should one of the servers fail, each of the other servers in each subset p will accommodate the failed server's share of those users. Thus, the processing load of each user group is handled with a redundancy of p (the number of servers in a subset), assuring a high level of availability.

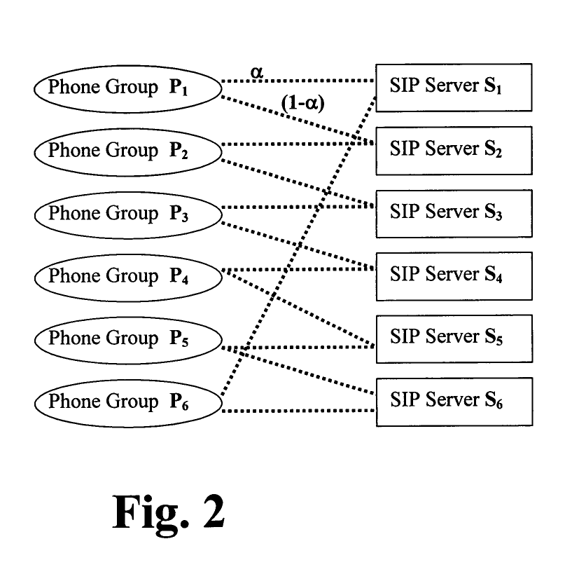

A preferred embodiment of the previously described network configuration is shown in FIG. 2. Illustrated are the communication links between a plurality of phone groups and a plurality of SIP servers. Although the phone groups are shown as communicating directly with the servers, it will be understood that these communications may actually be through a network. In this embodiment n=6, so six phone groups (user groups) P₁ through P₆ are illustrated, as an example. Each phone group may be a collection of phones or the users who are supported by the same SIP Server or IP-PBX. In practice, this often means the phones in the same office served by the same IP-PBX in that office. Also, m=6, so there are six SIP Servers, S₁ through S₆, each of which accommodates two phone groups (q=2) in the network. The dashed lines between the phone groups and servers indicate which SIP Servers accommodate the phones in each Phone Group and to which those phones are to register. For instance, all the phones in Phone Group P₁ register with SIP Servers S₁ and S₂; phones in Group P₂ with Servers S₂ and S₃; phones in Group P₃ with or Servers S₃ and S₄; and so on. At the bottom of the group assignment, the connection wraps back to the top.

To be precise, this assignment diagram is generated by the following mathematical algorithm:
Given n Phone Groups, labeled 1 to n, and also n SIP Servers, labeled 1 to n, each Phone Group i (i=1 to n) is assigned to two different SIP Servers j₁ and j₂ according to the following rule:

j₁=i

j₂=j₁+1(mod n)

This connection pattern is commonly known as a shuffle. The example of FIG. 2 corresponds to the case of n=6. The discussion continues using this example as an illustration.

Referring to FIG. 2, it can be assumed that for the traffic load generated in each Phone Group, a fraction a is sent to the server connected in the horizontal direction, and (1−α) is therefore sent in the diagonal direction as shown in the diagram, and 0≦a≦1. This same rule of traffic assignment is applied to all the Phone Groups for symmetry of load balancing.

Under normal operating conditions, the six servers are all active in a load sharing mode. When one server fails, the traffic originally accommodated by the failed server is redirected for service to the two other servers that accommodate the same users. For example, if SIP Server S₂ failed, all traffic from Phone Group P₁ would be served by SIP Server S₁, and all traffic from Phone Group P₂ by SIP Server S₃. It can be shown mathematically that for achieving the best load balancing condition given identical Phone Group traffic characteristics, the value of a should be 0.5. In other words, traffic from each Phone Group should be split equally between its two servers under normal conditions.

It should be noted that the traffic generated from each Phone Group to the assigned SIP Servers pertain only to the signaling messages. Accordingly, there are multiple ways to implement the intended effect of equally splitting the traffic between two SIP Servers, including assignment of successive session initiation requests randomly to the two servers or toggling the requests between the servers.

From the description so far, those skilled in the art will appreciate that the cost of the disclosed structure (using n servers) is less than a 1-for-n arrangement (using one server to protect n servers, which results in a total of n+1 servers). As for the memory requirements, the disclosed structure requires that each server provide sufficient memory to maintain a database of two Phone Groups, totally independent of how large n may become. Thus, this structure is scalable, and a remaining issue is whether the design achieves High Availability.

Availability of a system like a telephone switch is typically expressed as a fractional number. For example, a digital telephone switch for the Public Telephone Switched Network is often cited as highly reliable with an availability of 0.99999 (the so-called “five nine” standard). Using a simple calculation:

Average Downtime per Year=(365×24×60)(1−A)

where A is the availability number, the five-nine availability standard translates to only 5.3 minutes of average downtime per year.

This meaning of availability for a single server is reasonably clear. However, for a network of servers as shown in FIG. 2, the situation is not so clear. In order to avoid ambiguity, a stringent definition is adopted that if any one Phone Group loses service, the entire network is considered to be down. For example, if SIP Servers S₁ and S₂ have failed, then Phone Group P₁ is out of service, and the network is declared down, regardless of whether the other Phone Groups have service or not. With this definition, the availability of the network using the proposed HA configuration of FIG. 2 will be compared to a conventional design of 1-for-1 redundancy for each server.

As is shown in the accompanying Appendix, the disclosed structure has approximately the same availability (or reliability) as the 1-for-1 redundancy arrangement, using the above, stringent definition that no phone group is allowed to be out of service. This is remarkable considering that the disclosed structure is half the cost of the 1-for-1 scheme.

In summary, a preferred, method and highly efficient structure have been disclosed for providing High Availability (HA) for a SIP-based VoIP network consisting of n (n≧3) communication servers called SIP Servers providing service to n groups of users (or n Phone Groups). In our context, we use a stringent definition for HA to mean that all Phone Groups must receive service, and service delivery failure to any one group would render the entire network in “down” status. In the disclosed HA construction, some key networking characteristics are as follows:
The entire network has n SIP servers providing service to n Phone Groups.
Each Phone Group is assigned for service by two distinct SIP Servers.
For any two Phone Groups, one of the following two conditions must apply:
   (a) The Two Phone Groups are served by 4 distinct SIP Servers, or
   (b) the two Phone Groups are served by 3 distinct SIP Servers, that is, they are served by one common server.
For each SIP Server, it has to serve at most two Phone Groups, and it maintains relevant registration information for users (or phones) in these two groups continuously.
For every Phone Group, the phones in the group need to maintain their registration continuously with two distinct SIP Servers, and in case of a SIP Server failure, the phones must have the ability to switch service to the other working SIP Server, either automatically or manually.
   The advantages of the aforementioned HA construction are significant compared to other alternatives in the state of the art:
The proposed design requires only n SIP Servers to support n Phone Groups, versus 2n servers to do the same in a conventional 1-for-1 fully redundant arrangement. In broad terms, this amounts to a 50% cost reduction.
In the proposed design, each SIP Server is only required to have sufficient processing power and memory space to support at most two Phone Groups, completely independent of the size of the network n and thus making the design scalable to arbitrarily large n.
In spite of the equipment efficiency cited above, there is no compromise in the reliability achieved in the proposed design. In other words, the reliability or availability achieved in this design is comparable to that of the conventional 1-for-1 fully redundant arrangement for practical applications of interest.

Although a preferred embodiment of the invention has been disclosed for illustrative purposes, those skilled in the art will appreciate that many additions, modifications and substitutions are possible without departing from the scope and spirit of the invention as defined by the accompanying claims.

### Appendix: Availability Calculation

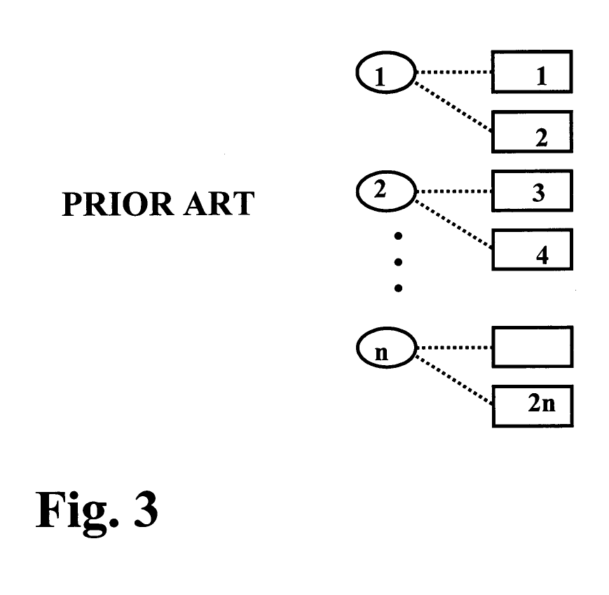

It is very complex to calculate an exact availability for the disclosed HA construction shown in FIG. 1. Instead, we will try to evaluate a performance bound and compare it to the reliability of the conventional 1-for-1 redundancy scheme. The conventional 1-for-1 redundancy construction is illustrated in FIG. 3.

With respect to FIG. 3, let A denote the availability for each server (or SIP Server). The availability A₂ for a pair of redundant servers serving a particular user group (Phone Group) is given by:

A₂=1−(1−A)²=A(2−A) (1)

which is the availability of each user group in FIG. 3. The total network availability AR for the 1-for-1 scheme in FIG. 3 is given by:

A_{R}=(A₂)ⁿ=Aⁿ(2−A)ⁿ (2)

### Since it is required that no user group is allowed to be down, the total availability is equivalent to the probability that all n groups are available.

It is very difficult to calculate the exact availability for FIG. 2. But those skilled in the art will appreciate that the following is a bound:

Aᵥ{Total HA network}>Aᵥ₃+Aᵥ₁+Aᵥ₂ (3)

where Aᵥ denotes the total availability, Aᵥ₃ denotes the availability when all servers are working, Aᵥ₁ denotes the availability when one server has failed, and Aᵥ₂ denotes the availability when two servers have failed which are not adjacent. In other words, Aᵥ is greater than the sum of the probabilities corresponding to those conditions in which the system would not be considered to have failed. This is a lower bound on Aᵥ:

A_{V}>Aⁿ+n(1−A)Aⁿ⁻¹+(ⁿC₂−n)(1−A)²Aⁿ⁻² (4)

where ⁿC₂ denotes n(n−1)/2. The values of equations (2) and (4) are computed in the following table for comparison.

| | Availability | Network | Network Availability |
|---|---|---|---|
| No. Of User | of Each | Availability for | Bound for the |
| Groups (n) | Server (A) | the 1-for-1 Scheme | HA Design (Aᵥ) |
| 4 | 0.99 | 0.99960006 | 0.99999960 |
| 4 | 0.999 | 0.99999600 | 0.99999999 |
| 6 | 0.99 | 0.99940015 | 0.99998044 |
| 6 | 0.999 | 0.99999400 | 0.99999998 |
| 8 | 0.99 | 0.99920027 | 0.99994606 |
| 8 | 0.999 | 0.99999200 | 0.99999994 |
| 10 | 0.99 | 0.99900044 | 0.99988615 |
| 10 | 0.999 | 0.99999000 | 0.99999988 |

In this table of values of practical interest, it can be seen that the performance of the proposed design is at least as good as the 1-for-1 scheme.

What is claimed:

1. In a network with a multiplicity of users and a plurality of supervisory servers, a method for providing high availability, comprising the steps of:
organizing the users into n user groups, each including a plurality of users, such that all the users in a group are part of a common database which permits intercommunication between them;
duplicating the database of a user group in a subset of p of the servers, which share the processing load of the corresponding user group, with each server accommodating users in q different groups;
upon failure of a server, causing other servers accommodating the failing server's users to accommodate the failed server's share of those users;
whereby the processing load of each user group is handled with a redundancy of p, improving the level of network availability.

2. The method of claim 1 wherein the network is a voice over Internet protocol (VoIP) network utilizing the SIP standard and the supervisory servers are SIP servers.

3. The method of claim 2 wherein p=2 and q=2.

4. A network with a multiplicity of users and a plurality of supervisory servers, comprising:
a program module executable by a computer and stored therein to maintain the organization of the users into n user groups, each including a plurality of users, such that all the users in a group are part of a common database which permits intercommunication between them;
storage media maintaining a copy of the database of a user group for a subset of p of the servers, which servers are to share the processing load of the corresponding user group, with each server accommodating q users in different user groups;
a control module responsive to the failure of a server, causing other servers accommodating the failing server's q users to accommodate the failed server's share of those users.

5. The network of claim 4 wherein the network is a voice over Internet protocol (VoIP) network utilizing the SIP standard and the supervisory servers are SIP servers.

6. The network of claim 5 wherein p=2 and q=2.

7. In a network with a multiplicity of users and a plurality of supervisory servers, a control subsystem comprising:
a first program module executable by a computer and stored therein to maintain the organization of the users into n user groups, each including a plurality of users, such that all the users in a group are part of a common database which permits intercommunication between them;
a second program module executable by a computer and stored therein causing storage media to maintain a copy of the database of a user group for a subset of p of the servers, which servers are to share the processing load of the corresponding user group, with each server accommodating q users in different user groups;
a control program module responsive to the failure of a server, causing other servers accommodating the failed server's q users to accommodate the failed server's share of those users.

8. The control subsystem of claim 7 wherein the network is a voice over Internet protocol (VoIP) network utilizing the SIP standard and the supervisory servers are SIP servers.

9. The control subsystem of claim 8 wherein p=2 and q=2.

10. An executable computer program for use with a network with a multiplicity of users' and a plurality of supervisory servers, the computer program being stored in a computer readable medium and comprising:
a first executable program module maintaining the organization of the users into n user groups, each including a plurality of users, such that all the users in a group are part of a common database which permits intercommunication between them;
a second executable program module causing storage media to maintain a copy of the database of a user group for a subset of p of the servers, which servers are to share the processing load of the corresponding user group, with each server accommodating q users in different user groups;
a third executable program module responsive to the failure of a server, causing other servers accommodating the failed server's q users to accommodate the failed server's share of those users.

11. The computer program of claim 10 wherein the network is a voice over Internet protocol (VoIP) network utilizing the SIP standard and the supervisory servers are SIP servers.

12. The control subsystem of claim 11 wherein p=2 and q=2.
